(19) United States
(12) Patent Application Publication
(10) Pub. No.: US 2015/0324634 A1
(43) Pub. Date: Nov. 12, 2015

(54) MONITORING A WAITING AREA

(71) Applicant: KONINKLIJKE PHILIPS N.V., Eindhoven (NL)

(72) Inventors: Angelique Carin Johanna Maria Brosens-Kessels, Eindhoven (NL); Jia Du, Waalre (NL); Jonathan David Mason, Waalre (NL); Paul Augustinus Peter Kaufholz, Eindhoven (NL); Azadeh Shirzad, Nieuwe Pekela (NL)

(21) Appl. No.: 14/649,652

(22) PCT Filed: Dec. 11, 2013
(86) PCT No.: PCT/IB2013/060787

§ 371 Date: Jun. 4, 2015

Related U.S. Application Data
(60) Provisional application No. 61/739,782, filed on Dec. 20, 2012.

(51) Int. Cl. G06K 9/00; H04N 7/18; G06F 19/00; G06F 17/30

(52) U.S. Cl. CPC G06K 9/00335; G06F 17/30554; G06F 17/3082; G06F 17/30247; G06F 17/30424; G06K 9/00288; H04N 7/183; G06K 9/00771; G06K 9/00369; G06F 19/324

(57) ABSTRACT

System (100) for monitoring a waiting area (010), comprising: —a database interface (120) for accessing a database (020) comprising identification data (022) of one or more scheduled persons scheduled for an event; —an identification subsystem (140) for i) receiving attribute data (152) indicative of an attribute of a waiting person in the waiting area, and ii) matching the attribute to the identification data, thereby establishing an identified person; —an emotion determining subsystem (160) for j) receiving physiological data (152, 172) indicative of a physiological parameter of the identified person, and jj) based on the physiological parameter, estimating an emotional state (320) of the identified person; and —a display processor (180) for visually representing the identified person (300-304) and the emotional state in an output image (182-188).

### FIELD OF THE INVENTION

The invention relates to a system and a method for monitoring a waiting area. The invention further relates to a computer program product comprising instructions for causing a processor system to perform said method.

Waiting areas are common in business, government and healthcare services. Typically, people sit or stand in such a waiting area until an event takes place for which they are waiting. The event may be a scheduled event, such as a doctor's appointment, a radiology examination, a passport renewal appointment, etc. Typically, the waiting area is constituted by a waiting room or a section of a room, and is typically provided with chairs. However, other forms of waiting areas are equally conceivable, e.g., outdoor waiting areas.

### BACKGROUND OF THE INVENTION

It may be desirable to enable a user, such as a business, government or healthcare worker, to monitor the waiting area. It is known to use a closed circuit television (CCTV) system for that purpose, which enables the user to monitor the waiting area by observing the waiting area on a television or other display. Such a CCTV system enables remote monitoring of the waiting area, e.g., from another room or another section of a waiting room. Accordingly, despite being located elsewhere, the user can observe whether a scheduled person has arrived, how many persons are waiting, etc. Advantageously, the user can adapt a workflow, adjust a schedule, etc., to a situation in the waiting area.

It is known to augment a video stream, such as one obtained from a CCTV system, with information associated with the person shown in the video stream.

For example, US 2011/0153341 describes a patient identification system which comprises a data storage storing patient information including patient identifying information associated with one or more patient images. The system further comprises a processor adapted to facilitate identification of a patient, receive a camera feed including an image of a patient, perform facial recognition using the camera feed to identify the patient in comparison with information stored in the data storage, retrieve information associated with the identified patient from the patient storage, and display the retrieved information in conjunction with the image of the identified patient on a computer screen.

### SUMMARY OF THE INVENTION

It would be advantageous to obtain a system, method and/or computer program product which enables a user to better monitor a waiting area.

The following aspects of the invention enable the user to better monitor the waiting area by identifying a person in the waiting area, estimating his/her emotional state, and visually representing the identified person and the emotional state in an output image.

In a first aspect of the invention, a system is provided for monitoring a waiting area, the system comprising:

a database interface for accessing a database comprising identification data of one or more scheduled persons scheduled for an event;

an identification subsystem for i) receiving attribute data indicative of an attribute of a waiting person in the waiting area, and ii) matching the attribute to the identification data, thereby establishing an identified person;

an emotion determining subsystem for j) receiving physiological data indicative of a physiological parameter of the identified person, and jj) based on the physiological parameter, estimating an emotional state of the identified person; and

a display processor for visually representing the identified person and the emotional state in an output image.

In a further aspect of the invention, a method is provided for monitoring a waiting area, the method comprising:

accessing a database comprising identification data of one or more scheduled persons scheduled for an event;

receiving attribute data indicative of an attribute of a waiting person in the waiting area;

matching the attribute to the identification data, thereby establishing an identified person;

receiving physiological data indicative of a physiological parameter of the identified person;

based on the physiological parameter, estimating an emotional state of the identified person; and

visually representing the identified person and the emotional state in an output image.

In a further aspect of the invention, a computer program product is provided comprising instructions for causing a processor system to perform the method set forth.

The inventors have recognized that a waiting person may react emotionally to a scheduled event and/or the waiting itself. For example, if the scheduled event is a medical examination or scan, the waiting person may be nervous or anxious. Similarly, if the waiting person has been waiting for a prolonged period of time, the waiting person may be irritated. The inventors have further recognized that the emotional state of the waiting person is of relevance to the user, as it may affect their workflow, schedule, etc. For example, an anxious person may need to be calmed prior to starting the medical examination or scan. However, said emotional state is typically not easily observed by a user of, e.g., a CCTV system.

The aforementioned measures enable a user to monitor a waiting area. For that purpose, a database is accessed. The database comprises identification data which identifies one or more persons which have an appointment, i.e., are each scheduled for an event and thus are considered a scheduled person. For example, the database may comprise a name of the scheduled person, a photograph, and/or other identification data. A waiting person is identified in the waiting area. For that purpose, attribute data is obtained which allows the identification determining subsystem to determine an attribute of the waiting person. The attribute tells apart the waiting person, e.g., from other persons waiting in the waiting area. The attribute may be, e.g., a biometric attribute of the person, a token-based attribute of a token carried by the person, etc. The attribute is associated with the waiting person, e.g., by being a physical feature of the waiting person, by being carried by the waiting person, etc.

The identification data is used to find a scheduled person which sufficiently matches the attribute. Hence, the waiting person is identified in that the waiting person in the waiting area is linked to the scheduled person identified by the identification data. In addition, physiological data is obtained which allows the emotion determining subsystem to determine a physiological parameter of the identified person, such as a body temperature, a pulse rate, a facial muscle position, etc. The physiological parameter is used to estimate an emotional state of the identified person. The emotional state is then visually represented in an output image together with a representation of the identified person.

The above measures have the effect that an output image is provided which, when viewed by the user, informs the user about the identified person in the waiting room and his/her emotional state. Consequently, the output image enables the user to monitor the waiting room, in that the waiting person is automatically identified and the result thereof is shown to the user. Moreover, the user simultaneously obtains feedback about the emotional state of the identified person. Advantageously, the user or other worker can react to the emotional state. For example, if the identified person is shown to be anxious, the identified person can be calmed down before the scheduled event. Advantageously, the user can better maintain the workflow and/or the schedule. Advantageously, it is less likely that a scheduled event is prolonged due to an unsuitable emotional state of the identified person.

Optionally, the system further comprises a video recording subsystem for obtaining a video image of the waiting area showing the identified person, and the display processor is arranged for including the video image in the output image. By providing the video image to the user, an image-based representation of the identified person is provided to the user. Advantageously, the video image enables the user to better monitor the waiting area.

Optionally, the display processor is arranged for visually representing the emotional state in an overlay in the video image. The video image thus shows the identified person with his/her emotional state being visualized in as part of an overlay in the video image. Advantageously, the overlay is visually linked to the identified person in the video image to enable the user to intuitively associate the emotional state with the identified person.

Optionally, the video image constitutes the attribute data, and the identification subsystem is arranged for identifying the attribute of the identified person based on an analysis of the video image. The attribute is thus identified using the video image, i.e., using the image-based representation of the identified person in the video image, and in particular by analyzing the video image. Advantageously, there is no need for separate identification sensors in the waiting area. Rather, the video recording sensors of the video recording subsystem are used instead, e.g., an existing CCTV camera.

Optionally, the identification subsystem is arranged for using facial recognition to match a facial attribute of the waiting person to the identification data. Facial attributes are well suited for identifying the waiting person in the video image. Advantageously, the identification data comprises an image-based representation of the scheduled person, i.e., a photograph, thereby facilitating matching the facial attribute of the waiting person to the identification data.

Optionally, the video image constitutes the physiological data, and the emotion determining subsystem is arranged for obtaining the physiological parameter of the identified person based on an analysis of the video image. The physiological parameter is thus obtained from the video image, i.e., from the image-based representation of the identified person in the video image. Advantageously, there is no need for separate physiological sensors in the waiting area. Rather, the video recording sensors of the video recording subsystem are used instead, e.g., an existing CCTV camera.

Optionally, the database comprises further information associated with the identified person, and the display processor is arranged for visually representing the further information from the database in the output image. Advantageously, a more informative output image is obtained.

Optionally, the further information from the database comprises at least one of the group of: a name of the identified person, a time of a scheduled event of the identified person, a remaining time until the scheduled event, a subject matter of the scheduled event, a physical need of the identified person prior to the scheduled event, and a psychological need of the identified person prior to the scheduled event.

Optionally, the identification subsystem is arranged for determining a waiting time of the identified person in the waiting area, and the display processor is arranged for visually representing the waiting time in the output image.

Optionally, the emotion determining subsystem is arranged for estimating a change in the emotional state of the identified person, and the display processor is arranged for visually representing the change in the emotional state in the output image.

Optionally, the emotion determining subsystem is arranged for triggering an alert if the change in the emotional state exceeds a threshold.

Optionally, the database is indicative of a past physiological parameter of the identified person, and the emotion determining subsystem is arranged for determining estimating the change in the emotional state based on the past physiological parameter.

Optionally, the system comprises a mobile display device for displaying the output image. By displaying the output image on a mobile display device, the user can easily recognize the identified person in the waiting room by verifying the output image.

It will be appreciated by those skilled in the art that two or more of the above-mentioned embodiments, implementations, and/or aspects of the invention may be combined in any way deemed useful.

Modifications and variations of the method and/or the computer program product, which correspond to the described modifications and variations of the system, can be carried out by a person skilled in the art on the basis of the present description.

The invention is defined in the independent claims. Advantageous yet optional embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for monitoring a waiting area;

FIG. 2 shows a method for monitoring the waiting area;

FIG. 3 shows a computer program product for performing the method;

FIG. 4 shows an output image comprising a text-based representation of the identified person and a graphical representation of the emotional state;

FIG. 5 shows an output image comprising a video image of the waiting area with the emotional state being visually represented in an overlay in the video image;

FIG. 6 shows the overlay comprising further information; and

FIG. 7 shows an alternate representation of the emotional state.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

FIG. 1 shows a system 100 for monitoring a waiting area 010. The waiting area 010 is shown schematically in FIG. 1 in the form of a waiting room. The system 100 comprises a database interface 120 for accessing a database 020. The database 020 may be an external database. For example, if the system 100 is used in a healthcare environment, the database 020 may be part of a Healthcare Information System (HIS). The database 020 comprises identification data 022 which identifies one or more scheduled persons scheduled for an event. For example, the database 020 may comprise a patient schedule and one or more patient records of the scheduled patients. The patient records may constitute medical records which comprise medical information. Alternatively, such patient records may lack medical information and rather constitute administrative patient records. The system 100 further comprises an identification subsystem 140 for identifying a waiting person 012 in the waiting area. In particular, the identification subsystem 140 is arranged for receiving attribute data indicative of an attribute of the waiting person 012 in the waiting area, and for matching the attribute to the identification data 022, thereby establishing an identified person.

For that purpose, the identification subsystem 140 receives the identification data 022 from the database 020. Moreover, in the example shown in FIG. 1, the identification subsystem 140 is connected to a video recording subsystem 150 which is located at least partially in the waiting area 010. The video recording subsystem 150 may obtain a video image 152 of the waiting area 010, e.g., using a video camera comprised in the video recording subsystem 150. The identification subsystem 140 may then use the video image 152 to identify the waiting person 012. In particular, the identification subsystem 140 may analyze the video image 152 to identify the attribute of the waiting person 012, e.g., based on facial recognition. As such, the attribute data may be constituted by the video image 152. For example, a same or similar system may be used as described by US 2011/0153341. It will be appreciated, however, that the identification subsystem 140 may also use any other suitable identification technique, as known per se from, e.g., the field of identification of human individuals. For example, instead of using a video recording subsystem 150, the identification subsystem 140 may make use of radio-frequency identification (RFID) where the waiting persons are issued with RFID tags and the waiting area 010 is equipped with RFID sensors. Thus, the attribute of the waiting person 012 may be received from a RFID sensor.

The system 100 further comprises an emotion determining subsystem 160 for receiving physiological data indicative of a physiological parameter of the identified person 012, and for estimating an emotional state of the identified person based on the physiological parameter. In the example shown in FIG. 1, the emotion determining subsystem 160 is connected to one or more sensors 170 arranged in chair in the waiting area 010. The one or more sensors 170 may enable the emotion determining subsystem 160 to obtain the physiological parameter of the identified person 012, e.g., by measuring a heart rate, skin conductivity or other physiological of the identified person 012 when he/she is seated in the chair. In this example, the physiological data may thus be received in the form of sensor data 172 from the one or more sensors 170. It will be appreciated, however, that the emotion determining subsystem 160 may also use any other suitable emotion determining techniques, as known per se from, e.g., the field of human emotion detection. For example, instead of using the sensors 170 in the chair, the emotion determining subsystem 160 may also obtain the video image 152 from the video recording subsystem 150. The physiological parameter may then be determined based on an analysis of the video image 152. As such, the physiological data may be constituted by the video image 152. For example, the so-termed Eulerian Video Magnification technique may be used to obtain the pulse of the identified person 012 from the video image 152. Another example is facial expression analysis, which may be used to obtain the magnitudes of facial muscle motions of the identified person 012 from the video image 152 so as to estimate the emotional state of the identified person.

The system 100 further comprises a display processor 180 for visually representing the identified person and the emotional state in an output image 182-188. For that purpose, the display processor 180 is shown to receive identification data 142 from the identification subsystem 140 and emotional state data 162 from the emotion determining subsystem 160. FIG. 1 shows the output image 182-188 being provided to a display 080 for being displayed to the user. The display 080 may be part of a mobile display device such as a tablet device. As such, the user is enabled to view the output image 182-188 at various locations, e.g., while meeting the identified person 012 in the waiting area 010.

An operation of the system 100 may be briefly explained as follows. The database interface 120 provides access to the database 020. The identification subsystem 140 identifies a waiting person 012 in the waiting area 010 by receiving attribute data indicative of the attribute of the waiting person in the waiting area and by matching the attribute to the identification data, thereby establishing the identified person. As a result, the waiting person is identified, i.e., the waiting person becomes an identified person 012. The emotion determining subsystem 160 receives physiological data indicative of a physiological parameter of the identified person 012, and based on the physiological parameter, estimates an emotional state of the identified person 012. The display processor 180 then visually represents the identified person and the emotional state in an output image 182-188.

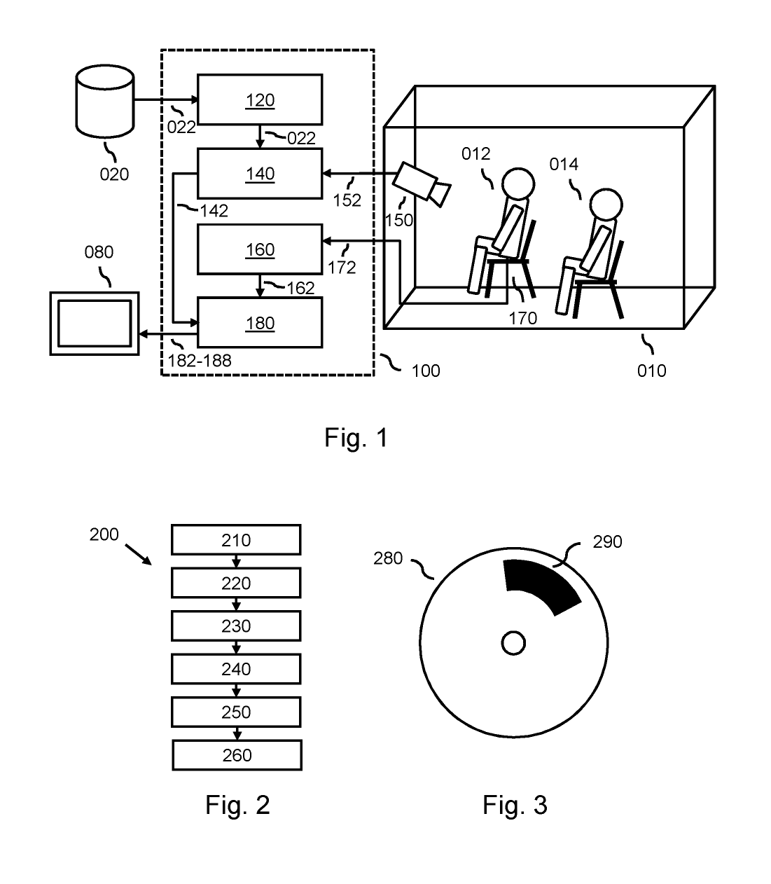

FIG. 2 shows a method 200 for monitoring a waiting area. The method 200 may correspond to an operation of the system 100. However, the method 200 may also be performed in separation of the system 100, e.g., using a different system or apparatus.

The method 200 comprises, in a step titled “ACCESSING DATABASE”, accessing 210 a database, the database being indicative of one or more scheduled persons scheduled for an event. The method 200 further comprises, in a step titled “OBTAINING ATTRIBUTE OF WAITING PERSON”, receiving 220 attribute data indicative of an attribute of a waiting person in the waiting area. The method 200 further comprises, in a step titled “IDENTIFYING WAITING PERSON”, matching 230 the attribute to the identification data, thereby establishing an identified person. The method 200 further comprises, in a step titled “OBTAINING PHYSIOLOGICAL PARAMETER”, receiving 240 physiological data indicative of a physiological parameter of the identified person. The method 200 further comprises, in a step titled “ESTIMATING EMOTIONAL STATE”, based on the physiological parameter, estimating 250 an emotional state of the identified person. The method 200 further comprises, in a step titled “GENERATING OUTPUT IMAGE”, visually representing 260 the identified person and the emotional state in an output image. It will be appreciated that the steps of the method 200 may be performed in any suitable order. In particular, the steps involved in identifying the waiting person and estimating the emotional state may be performed in a different order, e.g., simultaneously or in a reverse order. For example, the emotional state of a waiting person in the waiting area may be estimated, and only thereafter the waiting person may be identified.

FIG. 3 shows a computer program product 290 comprising instructions for causing a processor system to perform the aforementioned method 200. The computer program product 290 may be comprised on a computer readable medium 280, for example in the form of as a series of machine readable physical marks and/or as a series of elements having different electrical, e.g., magnetic, or optical properties or values.

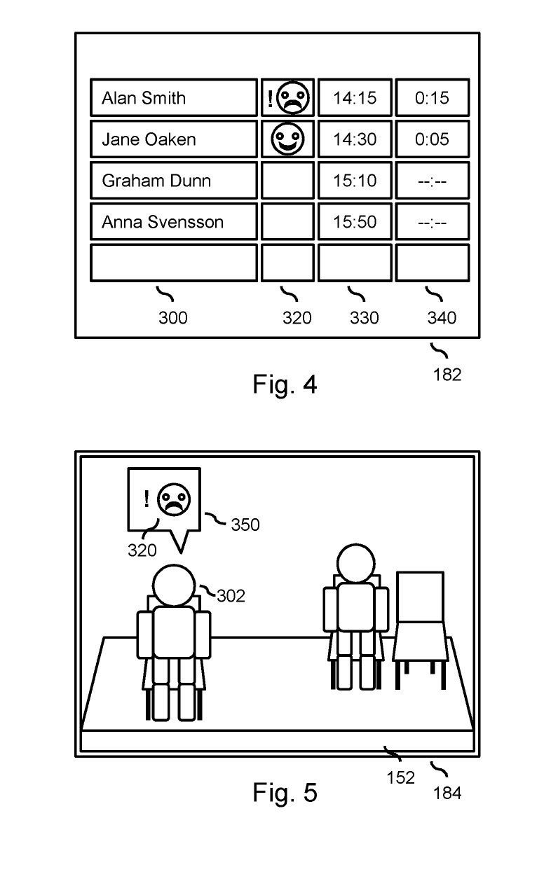

FIG. 4 shows an example of an output image 182 which may be generated by the system 100. Here, a schedule is shown which comprises a name 300 of the scheduled person and a time 330 of the scheduled event. This information may be obtained from the database 020. FIG. 4 further shows a result of two different waiting persons having been identified by identification subsystem 140, namely “Alan Smith” and “Jane Oaken”. This is implicit in FIG. 4 from the output image 182 showing a waiting time 340 of both of the waiting persons, i.e., 15 minutes for “Alan Smith” and 5 minutes for “Jane Oaken”. For that purpose, the identification subsystem 140 may be arranged for determining the waiting time 340 of the identified person 012 in the waiting area 010, and the display processor 180 may be arranged for visually representing the waiting time 340 in the output image 182. Both “Alan Smith” and “Jane Oaken” thus constitute identified persons in that the identification subsystem 140 matched an attribute of either of said persons to the database, thereby identifying which persons in the schedule are waiting in the waiting area 010. FIG. 4 further shows a result of the emotional state 320 of both identified persons having been estimated by the emotion determining subsystem 160. Here, the respective emotional states are indicated by smileys. The negative smiley for “Alan Smith” may denote an unsuitable state for the scheduled event, e.g., nervousness or anxiety. The positive smiley for “Jane Oaken” may denote a suitable state for the scheduled event, e.g., a non-negative or neutral emotional state.

The user may thus learn from the output image 182 of FIG. 4 that “Alan Smith” and “Jane Oaken” are waiting in the waiting area 010, and that the emotional state of “Alan Smith” is estimated to be unsuitable for the scheduled event. As such, the user or other worker may attempt to, e.g., calm down “Alan Smith” prior to the scheduled event.

The identified persons are visually represented in the output image 182 by their name 300, i.e., in the form of a text-based representation of each identified person. In addition, the emotional state 320 of each identified person is graphically represented, i.e., as a smiley. However, the identified person and the emotional state may be visually represented in the output image in various ways, as will be further explained in reference to FIGS. 5-7.

FIG. 5 shows another example of an output image 184 which may be generated by the system 100. Here the output image 184 comprises a video image 152 of the waiting area 010, with the emotional state 320 being visually represented in an overlay 350 in the video image 152. Here, the term overlay refers to information being visualized by overlaying the information over at least part of the video image. The video image 152 shows the identified persons in the waiting area, i.e., “Alan Smith” and “Jane Oaken”. As such, the output image 184 visually represents the identified persons in that the video image 152 provides image-based representations of the identified persons. The video image 152 may have been obtained from a video recording subsystem 150 as shown in FIG. 1. It is noted that the video image 152 may be obtained for the primary purpose of being included in the output image 184. Hence, the identification subsystem 140 and/or the emotion determining system 160 may not need to use the video image 152 but may rather use different sensors.

FIG. 5 shows the emotional state 320 of “Alan Smith” being included in a call-out sign 350 to the image-based representation 302 of “Alan Smith”. Hence, the visual representation of the emotional state 320 is visually associated with the image-based representation of “Alan Smith” 302. In general, the display processor 180 may be arranged for including the visual representation of the emotional state 320 in the video image 152 in visual association with that of the identified person 012. Similarly as in FIG. 4, the emotional state 320 is visually represented in the form of a smiley. The user may thus learn from the output image 184 of FIG. 5 the emotional state 320 of the identified person. The user is also provided with an image-based representation 302 of the identified person, thereby enabling the user to identify said person, e.g., when meeting “Alan Smith” to calm him down.

It is noted that the output image 184 of FIG. 5 may be considered an augmented reality output image 184 in that the video image 152 showing the identified person is augmented with information on the emotional state 320 of the identified person.

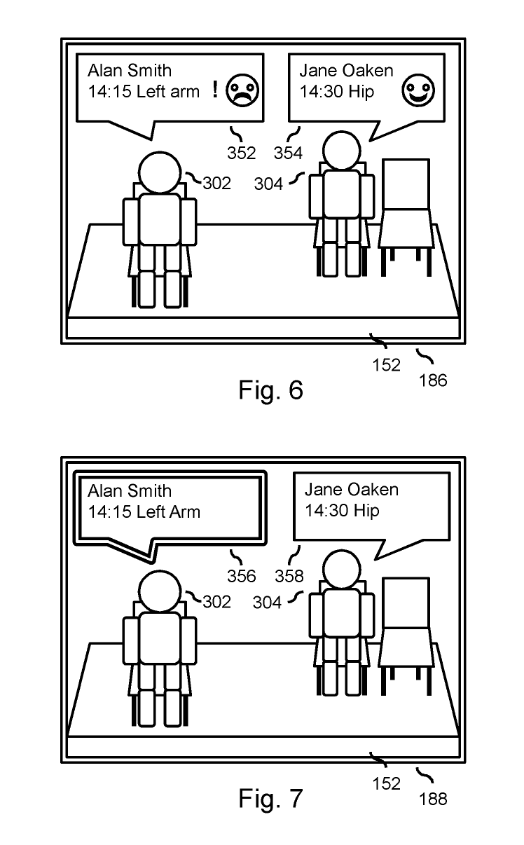

FIG. 6 differs from FIG. 5 in that further information from the database 020 is visually represented in the output image 186 in addition to the identified person 302 and the emotional state 320. By way of example, said information is included in the overlays 352, 354 to the image-based representations 302, 304 of each identified person, i.e., “Alan Smith” and “Jane Oaken”, respectively. In the example of FIG. 6, the name of the identified person, the time of the scheduled event, and the subject matter of the scheduled event are shown in each respective overlay. As such, the user may learn from the output image 186 of FIG. 6 that the person sitting on the left-hand side of the waiting area is “Alan Smith” who has an appointment at 14:15 for an examination of his left arm. Moreover, the user may learn that “Alan Smith” is estimated to be nervous, anxious or in another emotional state which is deemed to be unsuitable for the scheduled examination. Moreover, the user may learn that the person sitting on the right-hand side of the waiting area is “Jane Oaken” who has an appointment at 14:30 for an examination of her hip. Moreover, the user may learn that “Jane Oaken” is estimated to be calm or in another non-negative or neutral emotional state.

In general, the database 020 may comprise a name of the identified person, a time of a scheduled event of the identified person 012, a remaining time until the scheduled event, a subject matter of the scheduled event, a physical need of the identified person prior to the scheduled event, and/or a psychological need of the identified person prior to the scheduled event or various other relevant information for the user. The display processor 180 may be arranged for visually representing the information in the output image 186. As such, the user may learn that the identified person 302 may, e.g., have a physical disability and need transportation to the examination room, suffers from claustrophobia, has an allergy, etc.

It will be appreciated that the emotional state 320 may be visually represented in various ways. Hence, even though FIGS. 4-6 show the emotional state 320 in the form of smileys, other visualizations are equally conceivable. For example, FIG. 7 shows a same output image 188 as that of FIG. 6, except that the emotional state is visually represented in FIG. 7 by way of the border of the overlay being either double-lined, as is the case for the call-out sign 356 to the image-based representation 302 of “Alan Smith”, or being single-lined, as is the case for the call-out sign 358 to the image-based representation 304 of “Jane Oaken”. Here, a double-lined border may indicate to the user that the emotional state of “Alan Smith” is estimated to be unsuitable for the examination of his left arm, or more in general, needs attention of the user or other worker. Similarly, the single-lined border may indicate to the user that the emotional state of “Jane Oaken” is estimated to be calm.

The above examples distinguish between a negative emotional state such as nervousness and anxiety and a positive emotional state such as calmness. It will be appreciated that the emotion determining subsystem 160 may be arranged for estimating any relevant type of emotional state. In particular, the emotion determining subsystem 160 may arranged for identifying emotional states which may be of relevance for the scheduled events. Moreover, the display processor 180 may be arranged for visually representing said emotional states in the output image, while omitting visually representing emotional states which are not of relevance for the scheduled event. Hence, the visual representation of emotional states in the output image may essentially serve to warn the user of those persons in the waiting area which need attention from the user or other worker prior or during the scheduled event. The display processor 180 may thus omit visually representing in the output image the emotional states of persons who do not need attention from the user.

The above examples show the identification subsystem 140 identifying all waiting persons in the waiting area 010. It will be appreciated that the identification subsystem 100 may equally only identify one or any suitable number of waiting persons.

In general, identification subsystem 140 may be arranged for identifying the attribute from attribute data obtained from an identification sensor in the waiting area. The identification sensor may be, e.g., an image sensor from a video camera of the video recording subsystem 150. Similarly, the emotion determining subsystem 160 may be arranged for determining the physiological parameter of the identified person from physiological data from a physiological sensor in the waiting area. Said physiological sensor may be the same sensor as used for identifying the attribute, e.g., the image sensor of the video camera. However, this is not a limitation, in that the identification sensor and the physiological sensor may be different. Moreover, either or both of the sensors may rather be located outside of the waiting area 010 by being arranged for sensing inside the waiting area 010. For example, if the identification subsystem 140 uses Bluetooth-based discovery of a mobile phone of the waiting person to identify the waiting person, the Bluetooth receiver, i.e., the identification sensor, may be located outside of the waiting area 010 while being able to receive Bluetooth signals from inside of the waiting area 010. The system 100 may comprise said sensor(s) or, alternatively, be connectable to said sensor(s).

Moreover, in general, the emotion determining subsystem 160 may be arranged for estimating a change in the emotional state of the identified person 012, and the display processor 180 may be arranged for visually representing the change in the emotional state in the output image. The change in the emotional state may be a momentary change, e.g., a change occurring while the identified person is waiting in the waiting area 010. The change in the emotional state may also occur with respect to, e.g., a past visit of the identified person. For that purpose, the database 020 may be indicative of a past emotional state of the identified person, e.g., in the form of a past physiological parameter. The emotion determining subsystem 160 may be arranged for triggering an alert if the change in the emotional state exceeds a threshold. For example, an exclamation mark may be included next to the visual representation of the emotional state, or an audio alert may be triggered.

In general, the identification subsystem may be embodied in various ways. For example, the identification subsystem may use face recognition to match a waiting person to a database. For that purpose, the database may comprise photographs of scheduled persons. The photographs may be obtained from medical records of patients. The identification subsystem may also employ a tag-based identification technique in which a tag provided to a person during entry to the hospital. The tag may comprise information which allows identification of the person. The tag may be a passive tag or an active tag. The passive tag may be a visual tag, e.g., a card or a piece of paper comprising a machine readable code, e.g., a waiting number or a QR code. The machine readable code may be read from the video image which is obtained of the waiting area. The identification subsystem may also identify the waiting person using a personal device of the waiting person, e.g., by sensing a presence of his/her Smartphone, e.g., using Bluetooth discovery. Alternatively or additionally, the waiting person may also signal his/her presence by using an application on the Smartphone.

The emotion determining subsystem may be embodied in various ways. For example, as aforementioned, the physiological parameter may be obtained from a video image of the waiting area. Alternatively or additionally, the physiological parameter may be obtained from a personal monitor worn by the identified person. The personal monitor may be provided by a Smartphone of the person, e.g., in the form of an application running on the Smartphone which uses the Smartphone's sensors to measure the physiological parameter.

The video recording subsystem may comprise a video camera for obtaining a video stream of video images. The video stream may be a continuous video stream or an interval video stream. The video camera may be located in the waiting area. Additionally, video cameras may be provided in other areas, such as corridors, wards, patient rooms, etc.

It will be appreciated that the present invention may be advantageously used in a healthcare setting. For example, many radiology control rooms are provided with a display showing a live video of a waiting area. This enables a technologist to see if patients have arrived yet, are waiting, etc. A radiological examination is an exciting and in some cases even frightening event for patients. As a consequence, the technologist may frequently deal with anxious or phobic patients. Such patients require more attention and may need more time for scanning. This in turn may affect the workflow of the technologist and schedule for the following patients. For example, when a patient is very anxious and the technologist becomes aware of the anxiousness, the patient may be immediately offered some water or a chair so as to calm down the patient. It is therefore desirable for the technologist to become aware of the emotional state of a patient. The present invention may be advantageously used for this purpose. Advantageously, additional useful information may be displayed to the technologist, such as important allergy information, claustrophobia, transport needs etc. This may allow the technologist to speed up the patients' preparation for the examination.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. System for monitoring a waiting area, comprising:
a database interface for accessing a database comprising identification data of one or more scheduled persons scheduled for an event;
an identification subsystem for i) receiving attribute data indicative of an attribute of a waiting person in the waiting area, and ii) matching the attribute to the identification data, thereby establishing an identified person;
an emotion determining subsystem for j) receiving physiological data indicative of a physiological parameter of the identified person, and jj) based on the physiological parameter, estimating an emotional state of the identified person; and
a display processor for visually representing the identified person and the emotional state in an output image.

2. System according to claim 1, further comprising a video recording subsystem for obtaining a video image of the waiting area showing the identified person, and wherein the display processor is arranged for including the video image in the output image.

3. System according to claim 2, wherein the display processor is arranged for visually representing the emotional state in an overlay in the video image.

4. System according to claim 2, wherein the video image constitutes the attribute data, and wherein the identification subsystem is arranged for identifying the attribute of the identified person based on an analysis of the video image.

5. System according to claim 4, wherein the identification subsystem is arranged for using facial recognition to match a facial attribute of the waiting person to the identification data.

6. System according to claim 2, wherein the video image constitutes the physiological data, and wherein the emotion determining subsystem is arranged for determining the physiological parameter of the identified person based on an analysis of the video image.

7. System according to claim 1, wherein the database comprises further information associated with the identified person, and wherein the display processor is arranged for visually representing the further information in the output image.

8. System according to claim 7, wherein the further information from the database comprises at least one of the group of: a name of the identified person, a time of a scheduled event of the identified person, a remaining time until the scheduled event, a subject matter of the scheduled event, a physical need of the identified person prior to the scheduled event, and a psychological need of the identified person prior to the scheduled event.

9. System according to claim 1, wherein the identification subsystem is arranged for determining a waiting time of the identified person in the waiting area, and wherein the display processor is arranged for visually representing the waiting time in the output image.

10. System according to claim 1, wherein the emotion determining subsystem is arranged for estimating a change in the emotional state of the identified person, and wherein the display processor is arranged for visually representing the change in the emotional state in the output image.

11. System according to claim 10, wherein the emotion determining subsystem is arranged for triggering an alert if the change in the emotional state exceeds a threshold.

12. System according to claim 10, wherein the database is indicative of a past physiological parameter of the identified person, and wherein the emotion determining subsystem is arranged for estimating the change in the emotional state based on the past physiological parameter.

13. System according to claim 1, further comprising a mobile display device for displaying the output image.

14. Method for monitoring a waiting area, comprising:
accessing a database comprising identification data of one or more scheduled persons scheduled for an event;
receiving attribute data indicative of an attribute of a waiting person in the waiting area;
matching the attribute to the identification data, thereby establishing an identified person;
receiving physiological data indicative of a physiological parameter of the identified person;
based on the physiological parameter, estimating an emotional state of the identified person;
visually representing the identified person and the emotional state in an output image.

15. A computer program product comprising instructions for causing a processor system to perform the method according to claim 14.
